(19) United States
(12) Patent Application Publication
(10) Pub. No.: US 2023/0166305 A1
(43) Pub. Date: Jun. 1, 2023

(54) METHOD FOR REMOVAL OF FOULING FROM A PIPELINE

(71) Applicant: Halliburton Energy Services, Inc., Houston, TX (US)

(72) Inventors: Scott Robert Greig, Aberdeen (GB); Graham Peter Jack, Aberdeen (GB); Iain James Shepherd, Aberdeen (GB); Giselle Kevin Braganza, Aberdeen (GB)

(73) Assignee: Halliburton Energy Services, Inc., Houston, TX (US)

(21) Appl. No.: 17/538,424

(22) Filed: Nov. 30, 2021

(51) Int. Cl. B08B 9/032; B08B 7/00

(52) U.S. Cl. CPC B08B 9/0322; B08B 7/0071

(57) ABSTRACT

A method for removing fouling from a pipeline includes determining the location of fouling in the pipeline. Once determined, the method further includes installing a hot tap in the pipeline. A flex conduit is inserted into the pipeline through the hot tap and a treatment fluid is flowed into the pipeline through the conduit. The treatment fluid is used to remove the fouling from the pipeline. Once the fouling is sufficiently removed, the flexible conduit is removed from the pipeline.

### BACKGROUND

Fouling includes wax, asphaltene, scale, sludge, corrosion product, hydrate, sand or any other as debris or deposits that may form or accumulate in a pipeline. The substances can restrict flow through the pipeline and can cause other undesired consequences. Deposits that are formed within a producing pipeline can cause restrictions that in turn can impact both the throughput of the pipeline as well as the energy requirement to maintain design flow rates.

In the oil and gas industry, a tool known as a “pig” refers to any of a variety of movable inline inspection devices that are introduced into and moved (e.g., pumped, pushed, pulled, self-propelled, etc.) through a pipeline or a flow line. Pigs often serve various basic functions while traversing the pipeline, including cleaning the pipeline to ensure unobstructed fluid flow and separating different fluids flowing through the pipeline. Pigging in conjunction with chemicals can be used to remove deposits, however, there is a risk of stuck pigs, especially in heavily fouled pipelines. As the length of the pipeline increases, the volume of fouling increases and the amount of chemical cleaning agent required makes it less attractive. There is a further concern if the pipeline is not considered piggable. For heavily fouled pipelines, where mechanical pigging is not an option, the quantity of chemical required for treatment makes this an expensive option. In addition, disposal of large quantities of chemical makes it even less attractive.

Therefore, it is desired for a solution for removing fouling in an efficient manner.

### BRIEF DESCRIPTION OF THE DRAWINGS

Embodiments of the methods for treatment and removal of fouling from a pipeline are described with reference to the following figures. The same or sequentially similar numbers are used throughout the figures to reference like features and components. The features depicted in the figures are not necessarily shown to scale. Certain features of the embodiments may be shown exaggerated in scale or in somewhat schematic form, and some details of elements may not be shown in the interest of clarity and conciseness.

FIG. 1 is a schematic diagram of an exemplary environment for a system for removing fouling in a pipeline, according to one or more embodiments.

FIGS. 2A-2F are a series of schematic diagrams illustrating an exemplary method of removing fouling in a pipeline, according to one or more embodiments.

### DETAILED DESCRIPTION

The present disclosure describes methods and systems for treatment and removal of fouling from a pipeline. The pipeline may have any orientation or extend only in one direction or multiple directions, for example vertical or at an angle, along any axis, and may be but is not required to be horizontal. Fouling includes unwanted deposits, such as contamination, on the interior of the pipeline that interfere with flow through and reduce the efficiency of the pipeline. The fouling can extend into the bore of the pipeline any amount and in any shape and form to impede flow of the fluid. For example, in some areas, the fouling may completely block the bore of the pipeline. In other areas, the fouling may only partly block the bore. The fouling can be, for example, wax deposits, clay deposits, or any other possible deposits that can adhere to the wall of the pipeline such that the fluid flow is at least partly impeded.

The methods include determining the location of the fouling in the pipeline and installing one or more hot taps in the pipeline at a location within or near the fouling. The hot tap will generally be located as near as possible to the fouling location, but this may be optimized depending on the depth of burial of the pipeline, the seabed conditions, pipeline internal and external condition (e.g. corroded areas will be avoided) the pipe coating, the water depth, etc. If there is a long blockage or several small blockages to be treated, the hot tap may be located at a location within the length of fouling, to allow intervention in both directions. Generally, the location of the hot tap would preferably be within 5 km of the fouling, but potentially more with developing technology. For example, the hot tap may be located up to 10 km from the fouling. As another example, the hot tap may be located 1 km from the fouling. Preferably, the location of the hot tap is as close to the fouling as possible given the physical conditions. Installing the hot top at a location near the fouling also includes being close enough to the fouling to be effective in the treatment and removal of the fouling.

A flexible conduit is inserted into the pipeline through the hot tap and a treatment fluid is flowed into the pipeline through the inserted conduit to remove the fouling from the pipeline. The treatment fluid and the removed fouling are then flowed out of the pipeline through the hot tap. In addition, the flexible conduit is removed from the pipeline and then pipeline is then recommissioned to resume normal flowing operations. Further, these methods are not limited by the distance of the fouling location from either end of the pipeline or other access point in the pipeline.

Depending on the circumstances, such as the amount and type of fouling and the fluid normally flowing through the pipeline, the methods may also include sealing flow within the pipeline to isolate the fouling so that the treatment fluid may react with the fouling. The methods may also include flushing the pipeline with a flush fluid after the fouling is removed. The methods may also include swabbing the pipeline with a device after the fouling is removed to clean the pipeline.

The location of the fouling in the pipeline may be determined by any suitable method, include pressure or acoustic pulses sent into the pipeline and reflected to a receiver. Measurements from the receiver may be sent to a data acquisition system or processing unit to determine the location of the fouling. Depending on the location, the amount of fouling, the treatment fluid to be injected, and the normal fluid flow within the pipeline, the flow within the pipeline may optionally be sealed to isolate the fouling for treatment with the treatment fluid.

The installed hot tap or taps may be perpendicular to the pipeline or angled. Also, the flexible conduit may be any suitable conduit for injecting treatment fluid, such as coiled tubing, composite tubing, or the like. Material suitable for the flexible conduit may depend on many factors, such as water depth (hydrostatic pressures), material availability, and pipeline materials. An example is steel coil tubing. Depending on the nature of the fouling, the treatment fluid injected into the pipeline may be any fluid suitable for removing fouling in the pipeline environment. For example, the treatment fluid may comprise at least one of a solvent, an acid, a surfactant, an emulsion, a gel, an exothermic chemical, or a decontamination chemical. Additionally, the removed fouling and injected treatment fluid may be removed from the hot tap at the same time the treatment fluid is being flowed into the pipeline.

After the fouling is removed, the pipeline may be flushed with a flush fluid appropriate for cleaning out the removed fouling. The type of flush fluid may be selected based on the type of fouling being removed, the type of pipeline, and the fluid being transported in the pipeline. For example, the flush fluid may include fluid that includes solvents, diesel, condensates, acids, heated fluids, exothermic chemicals, scale or wax removers, gels, or a combination of these fluids. The flush fluid may be flowed into the pipeline through the flexible conduit after the treatment is complete and then flowed back out of the pipeline through the hot tap. As a further option, the pipeline may also be swabbed by moving a swab pig through the pipeline.

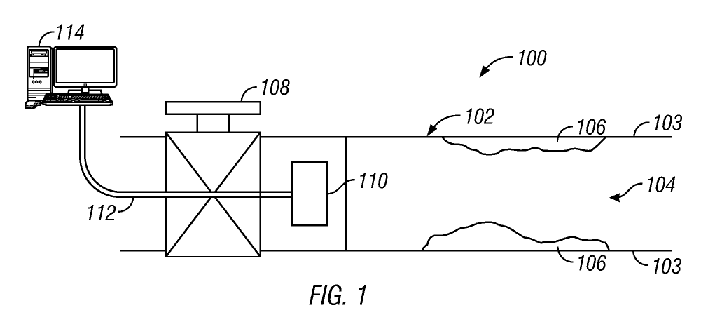

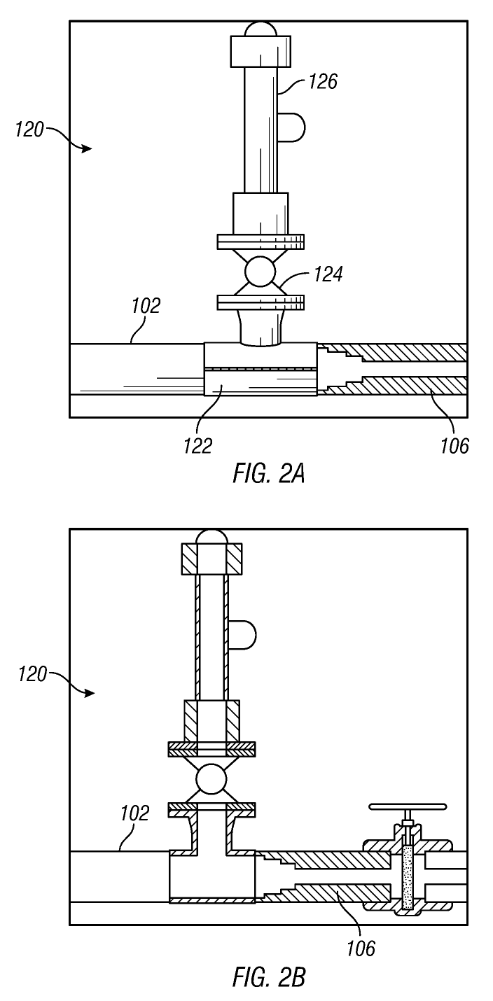

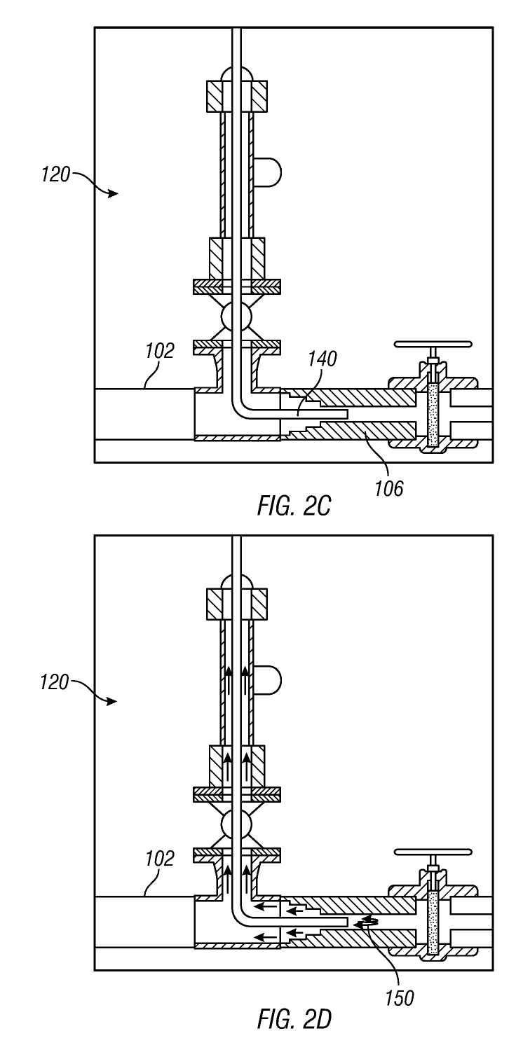

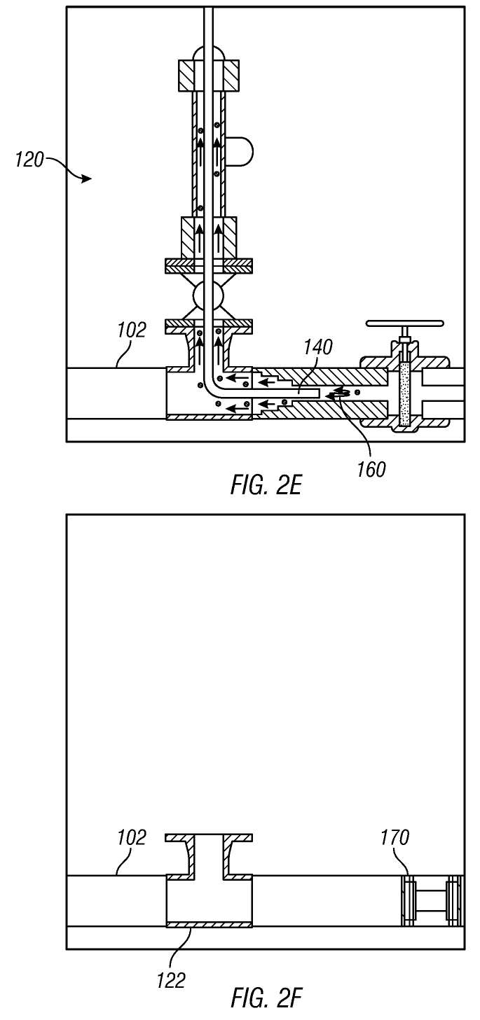

The method can be employed in an exemplary system 100 shown, for example, in FIGS. 1 and 2A-2F. FIG. 1 illustrates a schematic diagram of a fluidic channel such as a pipeline 102. The the pipeline 102 may have any orientation or extend only in one direction or multiple directions, for example vertical or at an angle, along any axis, and may be but is not required to be horizontal as schematically depicted in FIGS. 1 and 2A-2F. The pipeline 102 has a wall 103 that forms a bore 104 through which fluid can be contained in and flow. The fluid can be one fluid or more than one fluid. The fluid can include, for example, water, oil, or other hydrocarbons. The wall 103 of the pipeline 102 can form a cross-sectional shape such as substantially circular, ovoid, rectangular, or any other suitable shape. The wall 103 of the pipeline 102 can be made of any combination of plastics or metals, suitable to withstand fluid flow without corrosion and with minimal deformation.

Within the pipeline 102, for example along the wall 103, fouling 106 may form and deposit on the wall 103. The fouling 106 can extend into the bore 104 of the pipeline 102 any amount and in any shape and form to impede flow of the fluid. For example, in some areas, the fouling 106 may completely block the bore 104 of the pipeline 102. In some areas, the wall 103 of the pipeline 102 do not have any fouling 106 formed thereon. In yet other areas, the fouling 106 only partly block the bore 104. The fouling 106 can be, for example, wax deposits, clay deposits, or any other possible deposits that can adhere to the wall 103 of the pipeline 102 such that the fluid flow is at least partly impeded.

To determine the location of the fouling 106 within the pipeline 102, at least one pressure pulse, such as a water-hammer pulse, can be induced using transmission device 108. The transmission device 108 can create a pressure pulse that travels through the pipeline 102 at the local speed of sound in the medium. The transmission device 108 is not a permanent fixture or attachment. As such, the transmission device 108 can be disposed in the pipeline 102 or coupled with the pipeline 102 only when needed to create pressure pulses. In other examples, the transmission device 108 can be a permanent fixture in the pipeline 102. The transmission device 108 can be, for example, a valve. The transmission device 108 can create the pressure pulse by opening and closing the valve. When the valve is shut, a pressure pulse is generated that travels upstream of the valve. The transmission device 108 can be electrically programmed, such that different pressures can be induced based on the open and close sequences. The quicker the valve is opened and closed, the greater, or sharper, the pressure pulse.

As the pressure pulse travels along the pipeline 102, any encountered obstructions or fouling 106 generate a reflected signal which is received back at the transmission device 108. The system 100 includes a sensor 110 to receive the reflected pressure pulse signals. The sensor 110 can be a known distance from the transmission device 108. The sensor 110 can be a pressure transducer. In other examples, the sensor 110 can be any suitable sensor that measures pressure or stress of the fluid, for example a string gauge or an optical fiber transducer. The reflected signals are then passed through a transmission system 112 to a data acquisition system 114 to be interpreted to determine the location of any fouling 106 in the pipeline 102. The data acquisition system 114 can be at the surface, within a vehicle such as a submarine, or any other suitable location such that the data can be interpreted by an operator. The data acquisition system 114 can include a non-transitory computer readable storage medium. The non-transitory computer readable storage medium includes at least one processor and stores instructions executable by the at least one processor. The transmission system 112 can be wireline, optical fiber, wirelessly such as through the cloud or Bluetooth, or any other suitable method to transmit data.

As shown more clearly in FIG. 2A, after the location of the fouling 106 is determined, a hot tap 120 is installed in the pipeline 102 at a location near the fouling 106. The hot tap will generally be located as near as possible to the fouling location, but this may be optimized depending on the depth of burial of the pipeline, the seabed conditions, pipeline internal and external condition (e.g. corroded areas will be avoided) the pipe coating, the water depth, etc. If there is a long blockage or several small blockages to be treated, the hot tap may be located at a mid-point location, to allow intervention in both directions. Generally, the location of the hot tap would preferably be within 5 km of the fouling, but potentially more with developing technology. For example, the hot tap may be located up to 10 km from the fouling. As another example, the hot tap may be located 1 km from the fouling. Preferably, the location of the hot tap is as close to the fouling as possible given the physical conditions. Installing the hot top at a location near the fouling also includes being close enough to the fouling to be effective in the treatment and removal of the fouling.

The location of the hot tap will be based on diagnostic surveys performed on the pipeline to ensure an optimum location for the method. The diagnostic surveys determine the start and end locations of the fouling and the location of the hot tap 120 can be optimized to be near enough to the location of the fouling 106 with enough distance to effectively perform the methods of removing the fouling as discussed further below. The location may also be optimized based on the position of the fouling relative to any vessel at the surface in the case of a subsea pipeline, seabed conditions and whether the pipeline is buried or exposed for subsea pipelines, and available length of flexible conduit. It should also be appreciated that more than one hot tap 120 may be installed in the pipeline 102 within or near the fouling 106.

To install the hot tap 120, a reinforcing saddle or bracket 122 is placed around the pipeline 102 to form a seal against the outside of the pipeline 102. A valve 124 or other closure device is then attached to the bracket 122. A drilling tool (not shown) is then sealingly connected to the valve 124 and a drilling insert used to drill through the wall 103 of the pipeline 102. The drilling insert is then removed and the valve 124 closed. With the valve 124 closed, the drilling tool may be removed from the valve 124 and a side branch pipe 126 attached as shown. Although shown as a perpendicular hot tap, the hot tap 120 may alternatively be angled relative to the pipeline 102. The hot tap 120 is just one example of a hot tap and it is to be understood that other forms of hot taps may be used as well.

As shown in FIG. 2B, the example method may include sealing flow within the pipeline isolate the fouling. This can be done using a second hot tap, an existing valve on the line such as the valve 130 as shown, or an intrusive plug. The method of isolating the fouling may also include using an inflatable or expandable pig or any other suitable pipeline sealing device. However, sealing flow within the pipeline 102 may not be required depending on the type of remediation being performed.

As shown in FIG. 2C, after the hot tap 120 is installed, a flexible conduit 140 is inserted into the pipeline 102 through the hot tap 120. The conduit 140 provides a secondary path to allow for flowing into and return flow from the pipeline section. Also, although only one conduit is shown, two conduits 140 may also be inserted through the hot tap 120 for flowing treatment fluid into the pipeline 102. The flexible conduit 140 can also be equipped with high pressure jetting tools for injecting a treatment fluid at a high enough velocity to assist in removing the fouling 106. The high-pressure jetting tool may include, for example, a jet treating head assembly with a plurality of jet nozzles arranged such that a force imbalance is imparted to the jet treating head assembly by the reaction forces resulting from the jet action of the nozzles. The force imbalance urges the jet treating head assembly into proximity to the pipeline wall 103 to impart more force of the treatment fluid onto the fouling 106. Other injection control devices may also be included on the conduit 140. The material of the conduit 140 may be made up of any flexible material suitable to inject the treatment fluid into the pipeline 102 as well as the temperature of the treatment fluid and of the fluid in the pipeline 102. For example, the flexible conduit 140 may be coiled tubing or a composite conduit. Composite conduits may be any suitable composite materials, such as carbon fiber, plastic, metallic wire, etc. The flexible conduit 140 must also be long enough to be inserted through the hot tap 120 and reach a location suitable for injecting the treatment fluid into the pipeline 102 to remove the fouling 106. Part of the decision of the optimal location for the hot tap 120 may include the material and flexibility of the conduit 140. The shorter the distance away from the fouling 106, the more flexible the conduit 140 may be and still be inserted into the desired location in the pipeline 102. When inserted into the hot tap 120, the conduit 140 forms an annulus between the outside of the conduit 140 and the inside of the hot tap 120 for return flow.

As shown in FIG. 2D, with the flexible conduit 140 inserted, a treatment fluid is flowed either through the flexible conduit 140 as shown, or through the hot tap annulus, or through both, based on the type of treatment as shown with arrows 150. Returning treatment fluid 150 and removed fouling 106 can be pushed back through the hot tap annulus or the flexible conduit 140, as required. The treatment protocol and treatment fluid will vary based on the type of fouling 106 in the pipeline 102 and can include, but is not limited to the use of solvents, acid, surfactants, emulsions, gels, exothermic chemicals, decontamination chemicals, etc., or combinations thereof. If jetting is the technique being used, then chemicals may not be required in the treatment fluid at all. Instead, the force of the treatment fluid against the fouling 106 may be sufficient to remove the fouling 106 from the pipeline 102. The injected treatment fluid 150 and the removed fouling 106 may flow out of the pipeline 102 through the hot tap 120, the flexible conduit 140, or both.

As shown in FIG. 2E, once the fouling 106 has been removed, the pipeline section may be flushed with a flush fluid as shown with arrows 160 to clean out the entire hot tap 120 and pipeline 102 before pulling the flexible conduit out of the hot tap 120. The flush fluid 160 may be any suitable fluid for flushing out the treatment fluid 150 and removed fouling 106. For example, the fluid may include fluid that includes solvents, diesel, condensates, acids, heated fluids, exothermic chemicals, scale or wax removers, gels, or a combination of these fluids. Once flushed, the flexible conduit 140 may be removed from the pipeline 102. The valve 124 and the branch pipe 126 may then also be removed with the bracket 122 remaining in place to seal the pipeline 102 closed.

As shown in FIG. 2F, the embodiment method may optionally include swabbing the pipeline 102 by moving a swab pig 170 through the pipeline to remove and remaining material from the inside of the pipeline wall 103. This final swabbing of the pipeline 102 will ensure that anything that is left over from the procedure is swabbed out of the pipeline 102. Additionally, if the pipeline 102 was isolated using an inflatable or expandable pig, the same pig may be used as the swabbing pig 170 for the swabbing procedure.

Examples of the above embodiments include:

Example 1. A method for removing fouling from a pipeline, comprising: determining the location of fouling in the pipeline; installing a hot tap in the pipeline; inserting a flexible conduit into the pipeline through the hot tap; flowing a treatment fluid into the pipeline through the conduit; removing the fouling from the pipeline with the treatment fluid; and removing the flexible conduit from the pipeline.

Example 2. The method of Example 1, further comprising sealing flow within the pipeline to isolate the fouling.

Example 3. The method of Example 1, further comprising recommissioning the pipeline after the fouling is removed.

Example 4. The method of Example 1, further comprising flushing the pipeline with a flush fluid after the fouling is removed.

Example 5. The method of Example 1, further comprising swabbing the pipeline after the fouling is removed.

Example 6. The method of Example 1, wherein the treatment fluid comprises at least one of a solvent, an acid, a surfactant, an emulsion, a gel, an exothermic chemical, or a decontamination chemical.

Example 7. The method of Example 1, further comprising flowing at least some of the treatment fluid and removed fouling out of the pipeline through the hot tap.

Example 8. The method of Example 1, further comprising installing the hot tap in the pipeline at a location near the fouling.

Example 9. The method of Example 8, wherein the location is within 5 km of the fouling.

Example 10. A method for removing fouling from a pipeline, comprising: determining the location of fouling in the pipeline; installing a hot tap in the pipeline; sealing flow within the pipeline to isolate the fouling; inserting a flexible conduit into the pipeline through the hot tap; flowing a treatment fluid into the pipeline through the conduit; removing the fouling from the pipeline with the treatment fluid; and removing the flexible conduit from the pipeline.

Example 11. The method of Example 10, further comprising recommissioning the pipeline after the fouling is removed.

Example 12. The method of Example 10, further comprising flushing the pipeline with a flush fluid after the fouling is removed.

Example 13. The method of Example 10, further comprising swabbing the pipeline after the fouling is removed.

Example 14. The method of Example 10, wherein the treatment fluid comprises at least one of a solvent, an acid, a surfactant, an emulsion, a gel, an exothermic chemical, or a decontamination chemical.

Example 15. The method of Example 10, further comprising flowing at least some of the treatment fluid and removed fouling out of the pipeline through the hot tap.

Example 16. The method of Example 10, further comprising installing the hot tap in the pipeline at a location near the fouling.

Example 17. The method of Example 16, wherein the location is within 5 km of the fouling.

Example 18. A method for removing fouling from a pipeline, comprising: determining the location of fouling in the pipeline; installing a hot tap in the pipeline at a location near the fouling; sealing flow within the pipeline to isolate the fouling; inserting a flexible conduit into the pipeline through the hot tap; flowing a treatment fluid into the pipeline through the conduit; removing the fouling from the pipeline with the treatment fluid; flushing the pipeline with a flush fluid after the fouling is removed; swabbing the pipeline after the fouling is removed; and removing the flexible conduit from the pipeline.

Example 19. The method of Example 18, further comprising recommissioning the pipeline after the fouling is removed.

Example 20. The method of Example 18, wherein the treatment fluid comprises at least one of a solvent, an acid, a surfactant, an emulsion, a gel, an exothermic chemical, or a decontamination chemical.

21. The method of Example 18, further comprising flowing at least some of the treatment fluid and removed fouling out of the pipeline through the hot tap.

Certain terms are used throughout the description and claims to refer to particular features or components. As one skilled in the art will appreciate, different persons may refer to the same feature or component by different names. This document does not intend to distinguish between components or features that differ in name but not function.

For the embodiments and examples above, a non-transitory computer readable medium can comprise instructions stored thereon, which, when performed by a machine, cause the machine to perform operations, the operations comprising one or more features similar or identical to features of methods and techniques described above. The physical structures of such instructions may be operated on by one or more processors. A system to implement the described algorithm may also include an electronic apparatus and a communications unit. The system may also include a bus, where the bus provides electrical conductivity among the components of the system. The bus can include an address bus, a data bus, and a control bus, each independently configured. The bus can also use common conductive lines for providing one or more of address, data, or control, the use of which can be regulated by the one or more processors. The bus can be configured such that the components of the system can be distributed. The bus may also be arranged as part of a communication network allowing communication with control sites situated remotely from system.

In various embodiments of the system, peripheral devices such as displays, additional storage memory, and/or other control devices that may operate in conjunction with the one or more processors and/or the memory modules. The peripheral devices can be arranged to operate in conjunction with display unit(s) with instructions stored in the memory module to implement the user interface to manage the display of the anomalies. Such a user interface can be operated in conjunction with the communications unit and the bus. Various components of the system can be integrated such that processing identical to or similar to the processing schemes discussed with respect to various embodiments herein can be performed.

While compositions and methods are described herein in terms of “comprising” various components or steps, the compositions and methods can also “consist essentially of” or “consist of” the various components and steps.

Unless otherwise indicated, all numbers expressing quantities are to be understood as being modified in all instances by the term “about” or “approximately”. Accordingly, unless indicated to the contrary, the numerical parameters are approximations that may vary depending upon the desired properties of the present disclosure.

The embodiments disclosed should not be interpreted, or otherwise used, as limiting the scope of the disclosure, including the claims. It is to be fully recognized that the different teachings of the embodiments discussed may be employed separately or in any suitable combination to produce desired results. In addition, one skilled in the art will understand that the description has broad application, and the discussion of any embodiment is meant only to be exemplary of that embodiment, and not intended to suggest that the scope of the disclosure, including the claims, is limited to that embodiment.

1. A method for removing fouling from a pipeline, comprising:
determining a location of the fouling in the pipeline by sending a pulse through a fluid in the pipeline and receiving a reflection of the pulse from the fouling with a sensor;
installing a hot tap in the pipeline at an installation location near the location of the fouling;
inserting a flexible conduit into the pipeline through the hot tap;
flowing a treatment fluid into the pipeline through the conduit;
removing the fouling from the pipeline with the treatment fluid; and
removing the flexible conduit from the pipeline.

2. The method of claim 1, further comprising sealing flow within the pipeline to isolate the fouling.

3. The method of claim 1, further comprising recommissioning the pipeline after the fouling is removed.

4. The method of claim 1, further comprising flushing the pipeline with a flush fluid after the fouling is removed.

5. The method of claim 1, further comprising swabbing the pipeline after the fouling is removed.

6. The method of claim 1, wherein the treatment fluid comprises at least one of a solvent, an acid, a surfactant, an emulsion, a gel, an exothermic chemical, or a decontamination chemical.

7. The method of claim 1, further comprising flowing at least some of the treatment fluid and removed fouling out of the pipeline through the hot tap.

8. (canceled)

9. The method of claim 81, wherein the installation location is within 5 km of the location of the fouling.

10. A method for removing fouling from a pipeline, comprising:
determining a location of the fouling in the pipeline by sending a pulse through a fluid in the pipeline and receiving a reflection of the pulse from the fouling with a sensor;
installing a hot tap in the pipeline at an installation location near the location of the fouling;
sealing flow within the pipeline to isolate the fouling;
inserting a flexible conduit into the pipeline through the hot tap;
flowing a treatment fluid into the pipeline through the conduit;
removing the fouling from the pipeline with the treatment fluid; and
removing the flexible conduit from the pipeline.

11. The method of claim 10, further comprising recommissioning the pipeline after the fouling is removed.

12. The method of claim 10, further comprising flushing the pipeline with a flush fluid after the fouling is removed.

13. The method of claim 10, further comprising swabbing the pipeline after the fouling is removed.

14. The method of claim 10, wherein the treatment fluid comprises at least one of a solvent, an acid, a surfactant, an emulsion, a gel, an exothermic chemical, or a decontamination chemical.

15. The method of claim 10, further comprising flowing at least some of the treatment fluid and removed fouling out of the pipeline through the hot tap.

16. (canceled)

17. The method of claim 10, wherein the installation location is within 5 km of the location of the fouling.

18. A method for removing fouling from a pipeline, comprising:
determining a location of the fouling in the pipeline by sending a pulse through a fluid in the pipeline and receiving a reflection of the pulse from the fouling with a sensor;
installing a hot tap in the pipeline at an installation location near the location of the fouling;
sealing flow within the pipeline to isolate the fouling;
inserting a flexible conduit into the pipeline through the hot tap;
flowing a treatment fluid into the pipeline through the conduit;
removing the fouling from the pipeline with the treatment fluid;
flushing the pipeline with a flush fluid after the fouling is removed;
swabbing the pipeline after the fouling is removed; and
removing the flexible conduit from the pipeline.

19. The method of claim 18, further comprising recommissioning the pipeline after the fouling is removed.

20. The method of claim 18, wherein the treatment fluid comprises at least one of a solvent, an acid, a surfactant, an emulsion, a gel, an exothermic chemical, or a decontamination chemical.

21. The method of claim 18, further comprising flowing at least some of the treatment fluid and removed fouling out of the pipeline through the hot tap.
